(19) United States
(12) Patent Application Publication
(10) Pub. No.: US 2009/0149285 A1
(43) Pub. Date: Jun. 11, 2009

(54) Baseball bat utilizing stepped dowels

(75) Inventor: Michael R. Miller, Winnetka, IL (US)

Correspondence Address: Welsh & Katz, Ltd., 22nd Floor, 120 South Riverside Plaza, Chicago, IL, 60606-3912, US

(73) Assignee: Miller Dowel, Northfield, IL (US)

(21) Appl. No.: 11/999,966

(22) Filed: Dec. 7, 2007

(51) Int. Cl. A63B 59/06; B27M 3/22

(52) U.S. Cl. 473/564; 144/330

(57) ABSTRACT

A baseball bat comprising a base, a handle, and a barrel together defining a longitudinal axis wherein at least one pair of associated stepped dowels are disposed in the bat substantially perpendicular to the longitudinal axis and opposing each other.

### BACKGROUND OF THE INVENTION

The game of baseball is very popular in the United States and throughout the world, and is played by a wide range of people across a wide range of ages. Traditionally, baseball was played with a wooden bat. However, a disadvantage of wooden bats is their propensity to break while striking the ball. A wooden bat that breaks during use can be dangerous as a portion of the bat, which can be heavy and is sometimes sharp, can go flying toward the baseball players or spectators. These projectiles can cause serious injury. Further, broken bats are no longer usable in the game. Wooden bats can be expensive, and replacing broken wooden bats can be a costly disadvantage that can prevent individuals from purchasing and using wooden bats in games and during practice.

In response to some of the disadvantages of traditional wooden bats, other materials besides wood have been utilized. Particularly, metal bats, including aluminum, have been developed and utilized. Metal bats can be more durable than wooden bats, breaking less often. They are sometimes used by people who want to play baseball but do not have sufficient funds to buy a stock of wooden bats, which break more often. For example, many municipalities with limited resources will provide metal bats because of the potential cost savings. However, metal bats also have disadvantages. They can have widely differentiating performance characteristics in different weather conditions. Further, they can be dangerous. Perhaps because of a trampoline-like effect, balls struck by metal bats can travel at dangerously high velocities. The speeding struck balls can strike other players and/or spectators and cause serious injury and/or death. In response to this danger, numerous municipalities and other institutions have banned the use of metal bats.

It would be desirable to have a wooden bat that is less likely to break.

### BRIEF SUMMARY OF THE INVENTION

It has been found that a baseball bat comprising dowels placed at least in the handle area and potentially in the barrel. It is preferable that the bat and dowels are made of wood, preferably the same type of wood. The dowels preferably comprise at least two contiguous dowel sections having different cross-sectional size, and are preferably paired in adjacent areas and positioned perpendicular to the longitudinal axis of the baseball bat.

### BRIEF DESCRIPTION OF THE DRAWING

FIG. 1 is a perspective top view of the bat.

FIG. 2 is a side view of the bat.

FIG. 3 is an expanded view of a cross-section of the bat.

### DETAILED DESCRIPTION OF THE DRAWING

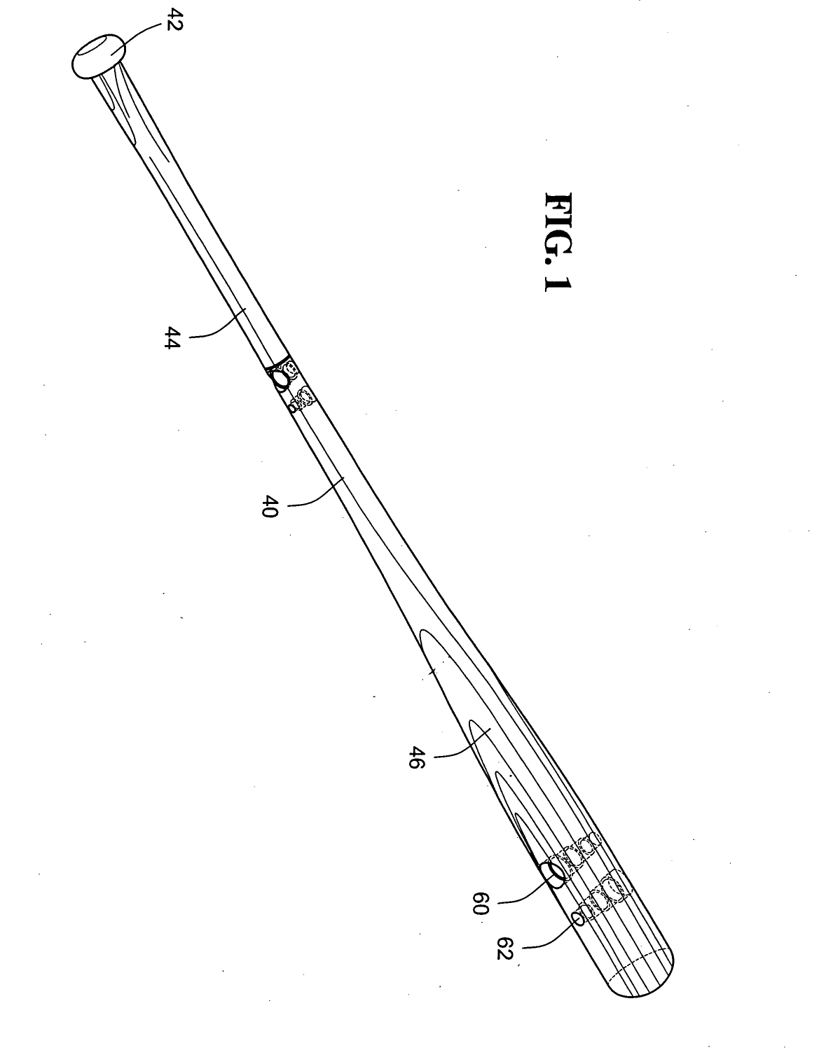

FIG. 1 shows an embodiment of a baseball bat 30 utilizing dowels. The bat has a base 42, a handle area 44, a barrel 40 and 46 and an end 58. The base of the bat can include a butt or knob. The bat can be comprised of wood. The type of wood can be of any variety, such as Ash, Maple, Hickory, Bamboo or other types of wood. The bat can be comprised of one type of wood, or it can be comprised of different woods that are held together by adhesives or other means that are known in the art.

The bat 30 defines a longitudinal axis that extends from its base 42 to the barrel 46. It is preferable that the bat is thinner in the handle area 44 than in the barrel 40, 46. In understanding these terms in this patent application, it should be understood that the handle area generally refers to the proximal portion of the bat which is generally thinner while the barrel refers to the distal portion of the bat which is generally thicker. The handle area can have a thinner region and a thickening region where its circumference grows toward the barrel.

Wooden baseball bats are most likely to break in the thinner handle area. The bats generally break when the player hits a baseball either at the distal end of the barrel or in the handle area close to the proximal end of the barrel.

In FIG. 1, the bat has a pair of associated dowels in the bat. The dowel 10 can be of any type known in the art. Preferably, the dowel 10 is comprised of dowel sections 14 having side walls 16, step portions 17, a tip 18 and a base 20. Each dowel section 14 may have a substantially circular shaped cross section as taken perpendicular to the dowel section 14 longitudinal axis. As shown in FIG. 1, in one embodiment, dowel sections 14 may be substantially cylindrical in shape. Other embodiments of the dowel 10 may be constructed so that each dowel section 14 has a substantially square or triangular shaped cross section as taken perpendicular to the dowel section 14 longitudinal axis.

As shown in FIG. 1, the dowel sections 14 may extend from the base 20 and may be longitudinally axially aligned relative to the base 20 such that the dowel sections 14 are of descending diameter from the base 20 to the tip 18. Depending on the specific application, alternate embodiments of the dowel 10 may include two, three, four or more dowel sections 14. In one embodiment, the individual dowel sections 14 diameters may be sized in the range of 125 mm to 6 mm, 120 mm to 4 mm and 115 to 2.5 mm respectively. In alternate embodiments, the individual dowel sections' 14 diameters may be any size and may be joined in any combination required for the particular application that dowel 10 is being used in. The length of each individual dowel section 14 may vary considerably depending on the width of the baseball bat in the area that the dowel is inserted. In one embodiment, the dowel section 14 having the smallest diameter has a length that is as long as or longer than the length of any of the other dowel sections 14.

The material selection for the dowel 10 may be dictated by such factors as, the dimensions of dowel sections 14, number of dowel sections 14, material type and/or dimensions. A preferred embodiment of baseball bat will have the dowel 10 constructed of the same wood as used in the baseball bat. Another embodiment would have the dowel constructed of a similar type of wood. The similarity could be determined by hardness, weight, strength, or density. Another embodiment would have the dowel constructed of a different type of wood. The dowel could be selected from the group of woods including, for example, mahogany, fir, birch, cedar or pine, dependent on the desired property enhancement. The dowel 10 may also be constructed of a combination of two or more wood or wood like materials.

As shown in FIG. 1, step portion 17 may be formed by a ninety degree angle with respect to the dowel 10 longitudinal axis. However, depending on the application, the step portion 17 may be configured in a variety of different ways. In alternate embodiments of dowel 10, the step portion 17 may be beveled or convex in shape (not shown). Beveled step portion 17 may provide dowel 10 with increased strength to prevent breakage if dowel 10 experiences unusually high tensile or shear forces in a particular application. Also, depending on the type of material dowel 10 is constructed of, the beveled step portion 17 may provide a more strength in the baseball bat. In yet other embodiments, the step portion 17 may be recessed or concave in shape (not shown). In still yet other embodiments, the step portion 17 may be rounded or any other shape that will provide for proper operation of dowel 10 when used in a particular application (not shown). The dowel may be formed in a number of different shapes. The dowel can have outer ribs in one, some, or all of the dowel sections. The dowel could have grooves.

Dowel 10 may be constructed in a variety of different ways using a variety of different manufacturing tools and techniques. For example, dowel 10 may be constructed using a lathe, a tool that is well known in the art. Further, each individual dowel section 14 may be constructed separately and the individual sections 14 may be joined together to form the composite dowel 10. For example, in one embodiment, dowel sections 14 may be fixed together using any type of adhesive or the sections 14 may be fastened together using a fastener such as nails, metal posts or any other type of fastener that will provide for proper operation of dowel 10.

The pair of associated dowels 10 is preferably positioned in the thickening region in the handle of the bat. In another embodiment, the dowels 10 are positioned in the barrel of the bat. In another embodiment, multiple pairs of associated dowels are utilized. This could include two associated pairs in the handle, one associated pair in the handle and one in the barrel, or any number of combinations thereof. In the preferred embodiment, four pairs of dowels are positioned in the bat.

As shown in FIG. 1, the bat defines a longitudinal axis. Preferably a pair of dowels 10 are positioned in a spaced, parallel fashion substantially perpendicular to the longitudinal axis of the bat. The bat will usually have a grain. Many times, during use the bat will break by splitting along one of the grains of the bat. Preferably, the dowels are positioned generally across the grain of the bat. It is thought that the positioning across the grain of the bat will help prevent the bat from breaking. More preferably, one dowel of each pair is oriented in one direction and the other dowel is oriented in substantially the opposite direction. While preferable that the dowels be positioned such that they extend all the way through the bat, in another embodiment, the dowels may pass through only a portion of the bat; it is considered within the scope of the invention the dowels be inserted only through more than one half of the bat diameter at that point, such as five eighths of the diameter. Further, it is thought that the use of dowels oriented in opposition to one another may provide a cinching effect that strengthens the bat. The grain of the dowel head can be positioned to be aligned with the grain of wood in the bat or perpendicular to the grain or at an angle in between.

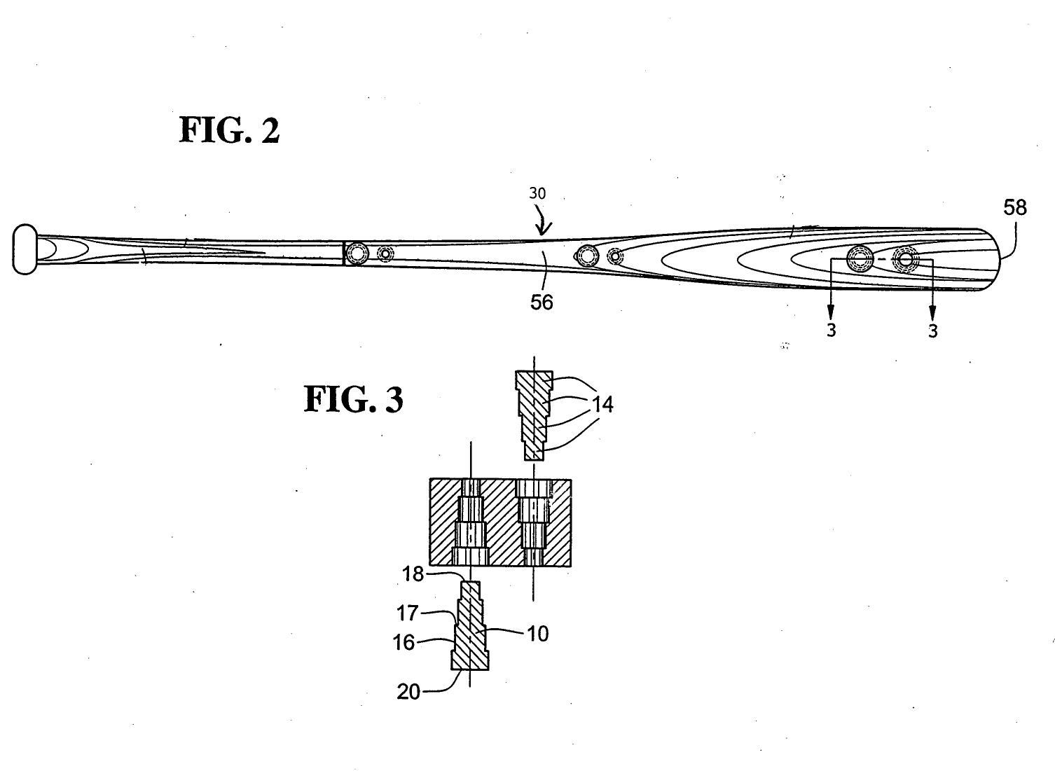

As more fully described in U.S. Pat. No. 6,267,527, FIGS. 5, 6, and 7 and the related description in the specification of which is incorporated by reference, a drill bit (not shown) with sections of different cross-sectional diameter can be utilized to create the pilot holes in the bat. Such pilot holes 60, 62 shown in FIG. 3 are of a size as will cause cinching of the dowel. The opening or bore 60, 62 is preferably sized so that it is slightly smaller than the dowel portions 14 that it is configured to receive. The dowel 10 may fit snugly into the opening 60, 62. Preferably, the dowel 10 and the opening 60, 62 form a friction fit. In a preferred embodiment, the dowel 10 can be partially inserted into the opening by hand. Because of the stepped nature of the dowel 10, the dowel 10 can be partially inserted into the opening with minimal force. The partially inserted dowel 10 in the opening of the bat is aligned with a selected bore 60, 62. The selected bore is configured to receive the portion of the dowel 10, either first or second 14. This receipt of the dowel shank, in a cinching fashion is achieved by machining the bore 60, 62 to a smaller cross section area. Thus, the bore 60, 62 cinches or grabs the dowel portions 14. While the bore is receiving the dowel in a cinching fashion, the bore or opening in the bat is machined so that the opening in the bat is the same size or larger than the dowel cross sectional area. This means that the dowel fits into the opening in a cinching and grabbing fashion caused by the compression of the dowel surface by the surrounding wood on the surface of the pilot hole or bore for a tight grip, caused by the ratio of the dowel cross sectional area to the pilot hole cross sectional area being greater than one, while the bore opening is simply a snug, taut, or firm fit to the dowel head 20 and does not cinch the dowel, caused by the ratio of the dowel cross sectional area to the pilot hole cross sectional area being less than one or equal to one. The dowels are held in the bat by cross sectional differences in the bore opening and the bore with the cross sections of the dowel portion 14, whereby the bore opening is equal to or very slightly larger than the dowel head 20 and less than the diameter of the dowel 10 in the middle and last sections 14. Alternatively, the second stage down from the top of dowel 10 can have a cross sectional area that is larger than the cross sectional area of the corresponding section stage of the pilot hole such that the cap portion of the dowel has a cross sectional area equal to or less than the cross sectional area of the bore opening and greater than the cross sectional area of the second section of dowel 10. This provides for cinching of the dowel within the bore while allowing a snug fit in the top cap portion of the dowel in the bore opening. The bores, or openings 60, 62 are formed as parallel, spaced openings, and may number as many as four pairs. They would optimally be placed in the central portion, or barrel of the bat if only one pair is utilized. If more than one pair is utilized, the, if for instance 4 pairs are utilized, such bores with associated dowels may be located in the handle region 44, at two spaced locations along the barrel region, such as 46 and 56, and at the end portion 58 as shown in FIGS. 1 and 2. If three pairs are intended, then they may be located as shown in FIGS. 1 and 2. The bores or openings may be all oriented similarly, i.e., in parallel, or each succeeding pair of bores may be positioned substantially perpendicular to the adjacent pair of bores.

While not seen in the Figures, it is preferred to have an adhesive material disposed in the hole of the bat and/or on the dowels to augment the connection. The adhesive material is preferably PVA, but can be any material that would adequately connect the parts of the pallet together, such as, e.g., hot melts, urethane, epoxy, PRF, or urethane/isocyanate. It is preferred that there is cinching in all stages of the dowel, i.e., the dowel is securely fixed to the bat with a hole to hole ratio of dowel to pilot hole in the range of 1.03:1.07. Other ratios can be used greater than or less than one to obtain full length cinching energy transition throughout the grain strata

In the preferred embodiment, the stepped configuration of the dowel provides easier alignment of the dowel with the hole of the bat during the insertion process. Further, significant pressure need be only applied to the dowel during, for example, approximately the last 20 percent of the insertion distance. A pounding device (not shown) may be used to insert the dowels. This device may be a hammer, mallet, or other suitable instrument. Preferably, the dowels fit snugly into the holes in the bat. Most preferably, the dowels form a friction fit with the inner surfaces of the holes. The stepped nature of the dowels positioned in the bat allows for them to be inserted more easily. The dowels are preferably not tapered because the dowels would have a tendency to pop out under such circumstances. It is thought that the insertion of the dowel causes the adhesive to radiate from the hole itself into the wood bat. The dispersed adhesive may help to create a stronger bat that is less likely to break.

The bat with dowels as described herein may also create a cinching effect between the dowel and the bat, which helps to maintain its strength. It is also thought that the dowels in the bat alter the harmonics of the bat. It may be theorized that normal bats may break in part because of the vibrations caused when hitting a ball at the distal end of the barrel or at or near the handle. The structure of a traditional bat might have certain harmonics that cause an amount of force to be focused on a certain area of the bat, making that area a weak spot that might be more susceptible to breaking. The inserted dowels may serve to disrupt the focalization of vibrations and thus prevent the creation of a weak spot that might eventually break. A second theory may also be that the dowels reinforce the bat by passing the dynamic energy throughout the piece allowing the absorption of the energy across all grains in unison instead of at the points of weakness. The weakest area in tension perpendicular to grain tension forces is the late wood early wood interface and the interface between radial rays and longitudinal cell walls by placing the dowels substantially perpendicular to the longitudinal axis of the bat. The applied dynamic load may be transferred more evenly to the entire bat and the dowels may act as reinforcements for weak grain zones and force translation agents.

In one embodiment of the invention, it may be desired to strengthen the bat to prevent breaking without significantly altering the performance of the bat. It may also be desirable for a doweled bat to have the same general look and feel of a traditional bat. It is therefore contemplated that the dowels and the bat be comprised of the same species of wood. In another embodiment, the dowels and the bat are comprised of similar species of wood.

The bat is preferably a single piece of wood. The bat including the dowels in effect creates a reinforced piece of wood. The bat with dowels is preferably of generally equal, homogeneous density as compared to a traditional bat comprised of one piece of wood with no dowels. In a preferred embodiment, the dowels do not create a hot spot or better sweet spot in the bat.

As seen in FIG. 3, the dowels can be inserted when the bat is in the form of a billet. Preferably, after insertion of the dowel, the adhesive is given time to set. The billet can then be put on a lathe where it is shaped into the form of a baseball bat. In another embodiment, the bat is largely formed, and then the dowels are inserted. The dowels are preferably sanded down or otherwise shaped to form a continuous, smooth surface with the outer surface of the bat.

In another embodiment, lacquer, paint, or other coatings may be put on all or part of the bat after it is shaped into its final shape. This coating may cover the dowels such that the dowels are not substantially visible.

Specific embodiments of novel apparatus and methods for construction of a baseball bat with dowels according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A baseball bat having a defined grain comprising a base, a handle, and a barrel together defining a longitudinal axis wherein at least one pair of associated stepped dowels are disposed within at least a central portion of the bat substantially perpendicular to the longitudinal axis, across the grain of the bat, said dowels being oriented in opposite directions and parallel.

2. The baseball bat of claim 1 wherein the baseball bat and the dowel consist of wood.

4. The baseball bat of claim 1 wherein the pair of associated spaced dowels are disposed in opposing parallel fashion.

5. The baseball bat of claim 1 wherein the dowels go partially through the bat.

6. The baseball bat of claim 14 wherein the baseball bat and dowel are of a similar type of wood.

7. The baseball bat of claim 1 wherein the dowels go all the way through the bat.

8. The baseball bat of claim 16 wherein the dowels are also disposed in the handle of the bat.

9. (canceled)

10. The baseball bat of claim 6 wherein the dowels are also disposed in the barrel of the bat.

11. (canceled)

12. The baseball bat of claim 16 wherein the bat defines a circumference and the dowels extend through the entire circumference of the bat.

13. The baseball bat of claim 1, wherein the stepped dowels have at least three sections of different cross sectional area.

14. A wooden baseball bat comprising a base, a handle and a barrel together defining a longitudinal axis, the baseball bat defining at least one pair of holes being substantially perpendicular to the longitudinal axis of the bat in at least a central portion of the bat and having at least two different cross sectional diameters;
the bat further comprising at least one pair of stepped dowels oriented in opposite directions and adhesive, both of which are disposed in the holes.

15. The wooden baseball bat of claim 14, wherein the adhesive is dispersed into some of the wood of the baseball bat near the holes.

16. The wooden baseball bat of claim 15, wherein the bat and dowels are of the same type of wood.

17. The wooden baseball bat of claim 14, wherein the holes are in spaced parallel fashion.

18. The wooden baseball bat of claim 14, including at least two pairs of holes and dowels.

19. (canceled)

20. The wooden baseball bat of claim 16 comprising at least two pairs of holes and two pairs of wooden stepped dowels.

21. The wooden baseball bat of claim 14, wherein the holes go completely through the wooden baseball bat.

22. The wooden baseball bat of claim 20 wherein the bat has a grain and the dowels are disposed across the grain of the bat.

23. The wooden baseball bat of claim 14, wherein the holes go partially through the wooden baseball bat.

24. The wooden baseball bat of claim 22, wherein the dowels disrupt the natural vibrations of the bat.

25. The wooden baseball bat of claim 14 including at least three pairs of holes and dowels.

26. A method of creating a doweled baseball bat comprising:
providing a piece of wood than can be formed into a baseball bat comprising a base, a handle, and a barrel;
providing at least one pair of stepped wooden dowels;
drilling at least one pair of stepped holes in the piece of wood, the holes being paired close to each other in parallel opposite directions and being substantially perpendicular to the longitudinal axis of the baseball bat;
placing adhesive in the holes;
inserting the dowels into the holes so that they form a snug fit and ensuring that the outer surface of the bat is substantially smooth.

27. The method of claim 26 wherein the insertion of the dowel causes some of the adhesive to disperse into the wood of the bat near the hole.

28. The method of claim 27, wherein at least two pairs of holes are drilled and at least two pairs of stepped wooden dowels are provided for an inserted.

29. The method of claim 28 wherein the insertion of the dowels creates a cinching action.
